(19) United States
(12) Patent Application Publication
(10) Pub. No.: US 2005/0228536 A1
(43) Pub. Date: Oct. 13, 2005

(54) Dispensing station

(76) Inventors: Guenther A. Mohr, Hamburg (DE); James Bond, Blacktown (AU); Anthony Van Staveren, Gladesville (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/822,156

(22) Filed: Apr. 8, 2004

(51) Int. Cl. G06F 17/00

(52) U.S. Cl. 700/237

(57) ABSTRACT

The present invention provides an Signaled dispensing station for laboratory items, for dispensing items only to authorized persons, and to facilitate management objects connected with the operation of the station. Dispensing transaction data is recorded and may be used for farther objects. Further it provides a method for dispensing items only to authorized persons, and to facilitate management objects like scheduling restocking. A system is also provided comprising at least one up to a plurality of inventive dispensing stations, the system being designed to facilitate the operation of the dispensing stations.

### BACKGROUND OF THE INVENTION

1. Technical Field

The present invention relates to an unmanned dispensing station, a method and a system for dispensing various items to authorized users only. It particularly relates to the dispensing of laboratory items in a laboratory environment.

2. Related Art

In laboratory environments certain items will be frequently used and may be offered, stored and dispensed in a boxed manner. Such items include for example reagents, solutions, slides, pipette tips, injection needles, pre-prepared samples and other disposable items. Especially items containing certain reagents will often require handling under special conditions, for example in a refrigerating or freezing unit. Dispensing such items is usually handled completely manually by a staff member, who also takes care of the freezing or refrigerating unit such that the unit will be closed properly after dispensing a reagent to a student or a researcher. As the items to be dispensed may also contain various hazardous materials and parts, it has to be ensured that only authorized personnel is provided with such items. Such materials may include poisons, radioactive materials, infective materials, reagents with short expiry time, or simply expensive items to be only used when strictly required. So usually the respective staff member will also have to ensure that only authorized persons will be handed over certain reagents or the like.

Of course this manual approach suffers from the serious drawbacks. Obtaining items stored in a certain freezer requires the presence of the person in charge. The availability is thus limited to the working hours of the respective person, who certainly will also have to perform other duties as well, so that obtaining an item may take a considerable amount of time and effort, if at all possible. Outside of common working hours it is rather likely that no one will be available to dispense needed items.

Providing a person to handle the dispensing is cost-intensive and would require more than one staff member to ensure availability of the needed items 24/7. This will especially be the case in a large laboratory environment with a plurality of freezers, refrigerating units or other item storage units to be handled. Thus usually every storage unit will be operated by another person, making it difficult and inconvenient to watch the amounts of certain items, schedule required restocking of the units or keep track of the usage of certain items.

If, for example, every student were allowed to use only a certain amount of reagent A or item B in his studies or experiments or in a certain period of time the manual approach does not provide appropriate ways of keeping track of such usage restrictions. Also it is likely that with such manual restriction management errors will occur, causing wrong items being dispensed or items being dispensed to the wrong person.

### SUMMARY OF THE INVENTION

The present invention provides a dispensing station, method and system for dispensing items to authorized persons, while it does not require any personnel, i.e. it is unmanned. It also provides means of registering the usage of items and facilitates management objects like the scheduling of restocking operations and the like. Further advantages and features of the present invention will become apparent from the following description.

The present invention provides an unmanned dispensing station for laboratory items. The station comprises an input terminal for identifying a user and authenticating said user, a central processing unit connected to said input terminal, an output unit comprising a sensor device connected to said central processing unit a memory device connected to said central processing unit, and a communication interface for transceiving data, connected to said central processing unit. The output unit comprises a locking mechanism to unlock said output unit for access of an authorized user and to close and lock said output unit to prevent unauthorized access. The output unit further comprises at least a first group of laboratory items arranged in a first order, wherein at least one item of said first group is located in a dispensing position, to be withdrawn from said output unit by said user. The sensor device is positioned in the vicinity of said dispensing position to detect a withdrawal. The memory device is adapted to store dispensing transaction data comprising the identity of said authorized user and the item group of said item, as well as withdrawal timing information. The central processing unit is adapted to control said locking mechanism to unlock said output unit upon successful authentication of said user, and to close and lock said output unit upon termination of a dispensing transaction, and said central processing unit is adapted to read dispensing transaction data from said memory and to send it to said communication interface. Thus a dispensing station is provided granting access to laboratory items only to authorized users, which does not require to be operated by personnel, The comprised sensors device enables to keep track of the amount and type of items withdrawn, so that the recorded dispensing transaction data can be utilized to facilitate the management objects connected with the operation of the dispensing station.

### BRIEF DESCRIPTION OF THE DRAWINGS

The present invention will be better understood by also referring to the accompanying drawings, in which:

FIG. 1 illustrates an embodiment of a dispensing station in accordance with the invention;

FIG. 2 illustrates the dispensing station of FIG. 1 in a working condition;

FIG. 3 illustrates an input terminal of a dispensing station in accordance with the invention;

FIG. 4 illustrates an embodiment of a system in accordance with the invention;

FIG. 5 is a flow chart of an embodiment of the dispensing method in accordance with the invention;

FIG. 6 is a flow chart of another embodiment of a dispensing method in accordance with the invention; and

FIG. 7 is a flow chart of a restocking process that is enabled by the present invention.

### DETAILED DESCRIPTION OF PREFERRED EMBODIMENTS

according to a first aspect of the present invention an unmanned dispensing station for laboratory items is provided. The station comprises an input terminal for identifying a user and authenticating said user, a central processing unit connected to said input terminal, an output unit comprising a sensor device connected to said central processing unit, a memory device connected to said central processing unit, and a communication interface for transceiving data, connected to said central processing unit. The output unit comprises a locking mechanism to unlock said output unit for access of an authorized user and to close and lock said output unit to prevent unauthorized access. The output unit further comprises at least a first group of laboratory items arranged in a first order, wherein at least one item of said first group is located in a dispensing position, to be withdrawn from said output unit by said user. The sensor device is positioned in the vicinity of said dispensing position to detect a withdrawal. The memory device is adapted to store dispensing transaction data comprising the identity of said authorized user and the item group of said item, as well as withdrawal timing information. The central processing unit is adapted to control said locking mechanism to unlock said output unit upon successful authentication of said user, and to close and lock said output unit upon termination of a dispensing transaction, and said central processing unit is adapted to read dispensing transaction data from said memory and to send it to said communication interface. Thus a dispensing station is provided granting access to laboratory items only to authorized users, which does not require to be operated by personnel. The comprised sensors device enables to keep track of the amount and type of items withdrawn, so that the recorded dispensing transaction data can be utilized to facilitate the management objects connected with the operation of the dispensing station.

It is preferred that the dispensing station further comprises an access device for accepting a personal identification module of said user. The access device is adapted to read personal authentication data stored on said personal identification module, to compare it with user authentication data stored in said memory device and to issue an authentication signal to said central processing unit upon matching of said read and said stored data. Authorization can thus be performed using identification modules like smart cards, USB memory sticks, subscriber identification modules SIM and the like. Access to the items comprised in that station is thus restricted to authorized user only, while providing a user a comfortable way to authorize himself for a dispensing transaction.

It is preferred that the access device is adapted to lock said personal identification module during a dispensing transaction, and to release said personal identification module for removal by said user only after said locking mechanism has locked said output unit subsequent to the termination of a dispensing transaction. So it can be ensured that the smart card or other identification module can be removed only if the output unit is properly closed. With output units comprising a freezer or the like this is important to ensure the proper storage conditions, for example a certain temperature. When the output unit is designed so as to be manually closed this would encourage the user to close it first. Otherwise an operator of the station can easily derive the last user because of the still locked smart card. Generally this improves the security against unauthorized use or vandalism.

It is preferred that the access device comprises an output section adapted to output or write dispensing transaction data to said personal identification module. This makes it possible to write a kind of receipt to the users smart card, for example a remaining amount of items to be withdrawn, or other information useful to the user, withdrawal times, group of items withdrawn etc.

It is preferred that the input terminal comprises a scanning device for scanning biometrical data of said user, adapted to compare said data with biometrical user data stored in said memory device and to issue an authentication signal to said central processing Unit upon matching of said scanned and said stored data. The biometrical data is selected from the group containing fingerprint, eye iris, face image and voice data Using biometrical data is a comfortable and secure way of performing the authorization of a user, and it does not require additional identification means to be carried around, that could be lost, stolen or otherwise corrupted.

It is preferred that the input terminal further comprises a display for displaying user instruction and dispensing status information, and an input device such as a keyboard or a pattern recognition device such as used in PDAs for entering a personal identification code of said user. The access device is adapted to transfer said personal identification code to said memory device, and said output section is adapted to delete any personal identification code stored on said personal identification module. The display can be utilized to display various useful information to a user, and the input device is required to enter a PIN for example. A further feature of the invention is to transfer the personal identification code from the personal identification module to the memory of the dispensing station, which provides for improved security. If besides the always required authentication data such a code like a PN is stored on the card, which can only be displayed by the dispensing station, this provides some advantages. The user can be sent a card comprising the code by usual mail, and at first use in an inventive station he is presented with the PIN to record it for later use, while it is subsequently deleted from the card There will thus be no way to derive the PIN from a stolen card. This feature enables a kind of registering method, PINs can also be exchanged after a while.

Preferably said dispensing station comprises an output unit comprising a refrigerating or freezing device for cooling or freezing of items comprised in said output unit, wherein at least all said laboratory items are contained in said refrigerating or freezing device. The refrigerating or freezing device may comprise a plurality of zones with different temperatures, or one or more zones comprising a temperature gradient. So various items possibly requiring different storage temperatures can be stored at the same time or in the same dispensing station, respectively, either by placing them in an appropriate temperature zone, or in the corresponding location with respect to the temperature gradient. Isolated zones with different temperature are possible, or the whole freezing unit may comprise a temperature gradient. Combinations of those possibilities are also conceivable.

It is preferred that the input terminal comprises a printer adapted to print out dispensing transaction data. The user can thus be given a printed receipt of the dispensing transaction. A receipt may either be printed for every single withdrawn item, or after the user has finished withdrawing multiple items a summary receipt indicating single items and the number of their withdrawals can be provided and/or printed. Further the receipt can comprise the name of the user, and other information useful to the user. For example a hotline number to call for notifying problems with the dispensing station or getting technical help or further information about products in the station, or sales information for present or future items.

It is preferred that the communication interface comprises a wireless communication module for wireless transmitting of said dispensing transaction data to at least one destination address. Thus the inventive dispensing station is made independent from wired interfaces that may not always be provided in locations where the station will be located, like common phone or network interfaces. Using a packet switched mobile phone transceiver module like one for GPRS/GSM/UMTS for this purpose offers the advantage to keep the costs low, as there will only be a relative small amount of data traffic. This can of course also be used advantageously to send dispensing transaction data to more than one address at the same time, for example the laboratory manager, the restocking dealer and the user. Other wireless network techniques can also be utilized, like W-LAN, bluetooth, RFID, ZigBee or the like.

It is preferred that the wireless communication module comprises a transmission section for preparing and sending one or more electronic mails containing dispensing transaction data to at least one destination address. This provides similar advantages as described above. If the wireless communication module is part of a wireless network this offers the possibilities of sending redundant mails to ensure proper receiving, with common wireless network connection or also the already mentioned GPRS or the like. Emails are very common today and provide great flexibility.

It is preferred that the wireless communication module comprises a transmission section for preparing dispensing transaction data for transmission to a web site. This may particularly useful when used in the laboratory of a university or tie like, which will very probably have a central computer server providing a centralized access to all staff members. So this feature can provide a comfortable way to keep track of item withdrawals and other dispensing transaction related data in a centralized manner, if the data is integrated into a commonly accessible web site.

It is preferred that the wireless communication module comprises a transmission section for preparing and sending one or more short messages (SMS) containing dispensing transaction data to at least one phone number or email address. This is another very flexible and useful way of notifying users or operators of the dispensing station about dispensing transactions.

It is preferred that the output unit comprises at least one movable tray adapted to be displaced between said dispensing position in which said tray is aligned with said order of said group of items to receive one of said items, and a removal position in which said tray is positioned to enable said user to remove an item. Dispensing position is supposed to mean that the tray is in the position where it already has received or does receive another (single) item from the group of items. In the removal position the user can withdraw the item, this can for example be achieved by extracting the tray as far as to be able to withdraw the item. This provides a comfortable way to extract items from output unit comprising a freezer for example. Thus it can easily be ensured that the freezer is always properly sealed, even while the user has extracted the tray far enough to get the item be wishes. After putting the tray back it is ready for the next dispensing transaction.

It is preferred that the wireless communication module comprises a receiving section for receiving restocking data comprising an item identification and an amount of reloaded items, wherein said receiving section is adapted to transmit said restocking data to said central processing unit for updating the content of said memory device according to said restocking data. A refiller or restocker is thus offered a convenient way to update the availability information in the dispensing station when he has restocked the amount of items, for example via his mobile phone.

It is preferred that the output unit comprises at least two trays, and said locking mechanism is adapted to selectively lock and unlock at least one of said at least two trays, and said central processing unit is adapted to control said selective locking or unlocking depending on said authorization of said user. Thus certain users can easily be restricted to certain items or groups of items they are allowed to use.

According to a second aspect of the present invention a method for dispensing laboratory items is provided. It comprises the steps of identifying and authenticating a user, unlocking an output unit for withdrawal of items by said authenticated user, sensing a dispensing transaction of said user, recording dispensing transaction data comprising the identity of said authorized user and the item identification, as well as withdrawal timing information, determining the termination of said dispensing transaction and locking said output unit, and transmitting said recorded dispensing transaction data to at least one destination address. Thus a dispensing method is provided granting access to laboratory items only to authorized users. The method enables to keep track of the amount and type of items withdrawn, so that the recorded dispensing transaction data can be utilized to facilitate the management objects connected with the operation of the dispensing station.

It is preferred that the termination of said dispensing transaction is determined by sensing that a predetermined period of time after unlocking of said output unit or a dispensing transaction has passed. Thus it can be ensured that the output unit will be closed after the time interval has passed, to prevent later unauthorized use.

It is preferred that the termination of said dispensing transaction is determined by sensing an indication of the termination entered by said user. Thus the user can indicate the termination and the output unit can be closed subsequently, without delay.

It is preferred that the number of currently available items is stored in said memory device, that said number is updated after the termination of a dispensing transaction according to said recorded dispensing transaction data, and that a restocking request is transmitted if said amount is less than a predetermined threshold amount. So it can be ensured that at all times the amount of currently available items is high enough to provide supply for possible users. Restocking can thus be performed only when needed, compared to fixed restocking times that may not be adapted to ensure supply at all times.

It is preferred that the recorded dispensing transaction data is outputted by printing out or displaying said data. The user can so be informed about the terminated dispensing transaction, or even take away a printed receipt. A receipt may either be printed for every single withdrawn item, or after the user has finished withdrawing multiple items a summary receipt may be provided and/or printed. Further the receipt can comprise the name of the user, and other information useful to the user. For example a hotline number to call for notifying problems with the dispensing station or getting technical help or further information about products in the station, or sales promotion information about present or future items.

It is preferred that the user is authenticated by reading a personal identification module, comparing personal authentication data read from said identification module with previously stored authentication data, and issuing an authentication signal upon a match of the compared authentication data. Using portable identification modules like smart cards or the like offers a comfortable, yet secure way of performing the required authorization.

It is preferred that the personal identification module is locked during a dispensing transaction, and released only after said output unit has been locked subsequent to the termination of a dispensing transaction. So it can be ensured that the smart card or other identification module can be removed only if the output unit is properly closed. With output units comprising a freezer or the like this is important to ensure the proper storage conditions, for example a certain temperature. When the output unit is designed so as to be manually closed this would encourage the user to close it first. Otherwise an operator of the station can easily derive the last user because of the still locked smart card. Generally this improves the security against unauthorized use or vandalism.

It is preferred that a personal identification code is received from said user and compared with a personal identification code stored on said personal identification module, wherein said authentication signal is issued only upon a match of both codes. This further improves security, as only users knowing also the right code will be granted access to the items.

It is preferred that said personal identification code is recorded upon a successful authentication, and deleted from said personal identification module afterwards. Thus it is impossible to derive the code from a stolen card. It further enables to exchange the code later on, the user will then be informed of the new code to use it for later accesses. This both generally improves the security of the authorization procedure.

It is preferred that dispensing transaction data is written to said personal identification module.

The user can thus be informed of certain status changes for example. Assumed that he is only allowed to withdraw a limited amount of items this can so easily be recorded on the module for the user to take notice.

It is preferred that the user is authenticated by scanning biometrical data of said user, comparing said biometrical data with previously stored biometrical data, and issuing an authentication signal upon a match of the compared biometrical data. Biometrical data, as described earlier, offer a flexible and comfortable way to perform authorizations.

It is preferred that dispensing transaction data is transmitted to a web site. The advantages of this feature have already been mentioned above.

It is preferred that one or more electronic mails containing dispensing transaction data are prepared, and sent to at least one address. Again refer to the previous discussion for the advantages connected with this.

It is preferred that one or more short messages (SMS) containing dispensing transaction data are prepared, and sent to at least one phone number or email address. See above.

It is preferred that restocking data comprising an item identification and an amount of restocked items is received, and that said number of available items is updated accordingly. After having performed a restocking transaction, the restocker can thus easily update the information about available items in a comfortable way.

It is preferred that the output unit comprises at least two trays for dispensing items, wherein said unlocking of said output unit comprises selectively unlocking at least one of said trays depending on said authorization of said user. As described earlier this offers the possibility to implement user-based restrictions to a withdrawal of items.

It is preferred that the output unit comprises at least two trays for dispensing items, and the method further comprises receiving an item selection from said user and unlocking at least one of said trays corresponding to said selection. So the user can easily select which items he wants and is given access to only those items. It also offers the possibility to let the user select the items he wants prior to opening a dispensing station. In case the dispensing station comprises a freezing unit wherein the items are stored, with an outer sealing door, this is advantageous to keep the time the outer door stays open as short as possible, to keep the storage temperature within a preferred temperature interval. The user can select the items be wants, and open the subsequently unlocked door only for removing the items, not for taking time to select them first.

According to a third aspect of the present invention a system for dispensing laboratory items is provided. The system comprises at least one inventive dispensing station, and a computer system comprising at least one communication interface adapted to connect with said at least one dispensing station, to receive dispensing transaction data. With such a system the management of a plurality of dispensing stations, for example in a large laboratory, can easily be performed. It is possible to use one or more servers as the computer system, e.g. one being located in the laboratory itself, and another one located at the restocker. All the necessary tasks for operating the plurality of dispensing stations can thus be handled in a centralized manner and be adapted to the specific needs or certain events. For example restocking can be scheduled only when needed, which will help to use resources more economically.

According to another aspect a software tool comprising program code means stored on a computer readable medium is provided, for carrying out the inventive method described above, when said software tool is run on a computer or network device.

According to another aspect a computer program product is provided, comprising program code means stored on a computer readable medium for carrying out the inventive method described above, when said program product is run on a computer or network device.

According to another aspect a computer program product is provided, comprising program code, downloadable from a server for carrying out the inventive method described above, when said program product is run on a computer or network device.

According to another aspect a computer data signal embodied in a carrier wave and representing a program that instructs a computer to perform the steps of the inventive method described above is provided.

According to the invention the input terminal for identifying a user and authorizing access to the dispensing station can comprise a number of devices. One way to achieve these objects would be to use a sort of card reader for smart cards or the like. A user would thus have to insert his smart card, possibly additionally enter a PIN code and would then be identified in a known manner, by comparison with previously stored authentication data. Two features of the present invention can be utilized in conjunction with smart cards or like personal identification modules. It is preferred that the card is received and locked after successful authorization, as long as the dispensing transaction takes place. The card will only be released to be removed from the input terminal after the user has finished the transaction, when the output unit has been closed and locked again. Thus it can be ensured that the dispensing station has locked the output unit against unauthorized use, before the card is released. Also in case the output unit comprises a freezer or other special storage device it is ensured that this will be properly closed after a transaction. As the user can only remove the card after proper closing of the output unit he will be forced to do so or wait until the unit has closed, respectively. Or otherwise the locked card will enable an operator to notice who left the unit open, in case this happens. This of course depends on the type of output unit, e.g. such units that have to be closed manually, or the ones that can be closed by a motor. Thus the latter is the most preferable implementation, where the dispensing station itself is in control of the closing and locking of the output unit.

Another feature associated with identity cards like smart cards is the personal identification code transfer. Cards for authorizing access to an inventive dispensing station may be sent to a user by mail for example. He will then only be provided with the card, a personal identification code like a PIN number or the like will not yet be revealed to him. The code will yet only be stored on the card itself, among the other authentication data When the user now first makes use of the card with an inventive dispensing station, the dispensing station will read the stored personal identification code and transfer it into the memory device. Subsequently it will delete the code from the card and display the code on the input terminal in order to enable the user to record it for further use. Deleting will mean that there will be no data left on the card to enable an unauthorized user, e.g. a thief of the card, to access the dispensing station by extracting the PIN from the stolen card. Access will only be allowed in combination with entering the personal identification code only known to the rightful owner of the card, and there will be no data to retrieve or derive that code from the card. Of course the user has to take care himself to record the code and keep it to himself. In the first-use situation it can be verified if he has noted the code by requesting him to enter it, and if he fails to do so the dispensing station could again display it until he has memorized it, and lock the card until proper entering of the code has occurred once. With this approach, as the PIN is only stored in the dispensing station, it is also possible to update the PIN. For example after a predetermined number of uses a new PIN could be provided by the station and be displayed for the user to record it for later use. In principle it is also possible to print out a slip containing the PIN for the user to take away, though this is less preferable due to reduced security.

Another embodiment of the present invention aims at a different approach of authorizing users. It is also possible to use certain biometrical data to identify a certain user. For this purpose a scanning device can be provided in the input terminal, and biometrical user data for a comparison can be stored in the memory device. Typical biometrical data useful for identification of a user could be the fingerprint, the properties of the iris of the users eye, an image of the users face, or even a recording of his voice for example. While this way of performing an identification provides more comfort to the user, it also prevents to use the feature of locking a personal identification module of a user until the output unit has been properly closed.

With the inventive dispensing station it is easily possible to associate users and items withdrawn by them. As dispensing transaction data are recorded for every transaction this provides many possibilities for using this data or gathering statistical data thereof.

Preferably only one item at a time can be withdrawn. Thus a user has to open and close a tray repeatedly if he desires a greater number of that item. For every single withdrawal the user can be given a kind-of receipt, either being displayed on a display of the input terminal, or getting a printed receipt by an optional printer.

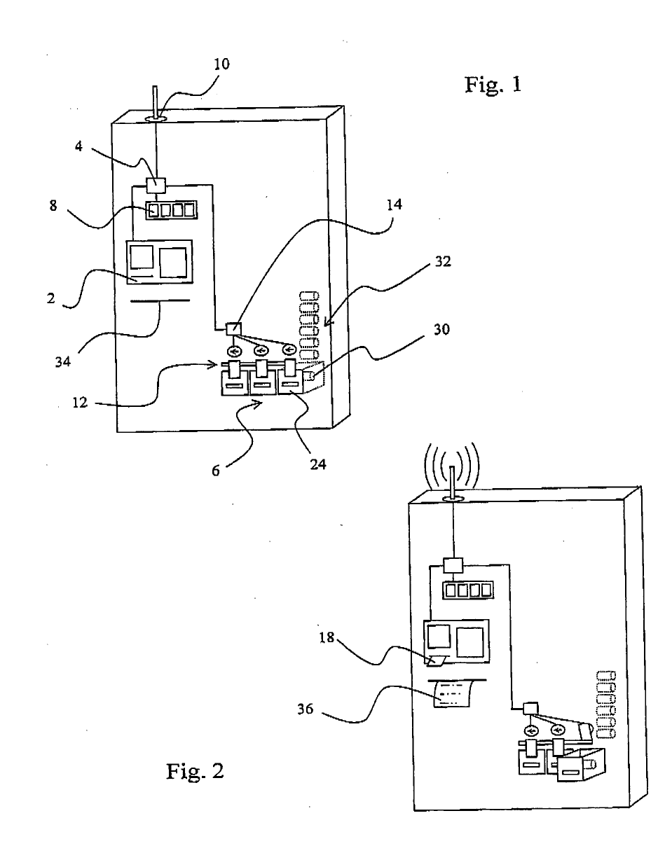

In FIG. 1 a preferred embodiment of the dispensing station according to the present invention is shown. It comprises an input terminal 2 for identifying and authorizing a user desiring to withdraw an item 30 from the dispensing station. The input terminal 2 is connected to a central processing unit 4, which in turn is connected with a memory device 8, a sensor device 14 and a communication interface 10. The sensor 14 device may be a mechanical sensor, a barcode scanner, an RFID-tag scanner or the like, such that it is capable of identifying withdrawn items. The items stored in the dispensing station are accessible through an output unit 6 comprising 3 trays in this example. The output unit 6 is protected against unauthorized use by a locking mechanism 12 keeping the output unit 6 closed and locked. The sensor device 14 comprises sensors for detecting withdrawals from the trays of the output unit 6. Items are arranged in a first group 32, wherein only one item 30 is located in a dispensing position. Further a slot of a printer 34 is shown. The central processing unit 4 controls the dispensing transactions, by identifying a user with the input terminal 2 and unlocking the output unit 6 in case of a successful authorization. Dispensing transaction data, i.e. the identity of the user and possibly other data like withdrawal time etc. are stored in the memory device 8. The processing unit 4 is enabled to retrieve dispensing transaction data from the memory device 8 to send it to the communication interface 10, by which it can be sent to the operator company of the dispensing station or others. Though a wireless communication interface is shown here, the communication interface 10 can, in alternative embodiments, also be an Ethernet network interface or other wired or wireless interfaces suitable to send and possibly receive data.

In FIG. 2 the dispensing station of FIG. 1 is illustrated in a working condition. For a description of the parts please refer to FIG. 1. A user has inserted a smart card 18 into the input terminal, where it stays locked during the dispensing transaction, i.e. until the user has withdrawn the item and the tray has been closed again. Processor unit 4 has verified the users authorization and unlocked the output unit 6. Please note that in this example selectively only one tray 24 of the output unit 6 has been unlocked, while in other embodiments all available trays may be unlocked at the same time. In the depicted case for example a student has been authorized to withdraw some kind of laboratory equipment, a pre-prepared slide for example. Items stored in other trays of the output unit are not accessible for him here. The unlocked tray 24 has been opened and is in a removal position, for the user to withdraw one item 30. A receipt 36 has been printed out to inform the user about the dispensing transaction. For example the student has been allowed to withdraw a certain amount of equipment items per month, and on the receipt 36 he is informed how many items there are left to withdraw. Also note that the communication interface 10 is sending out dispensing transaction data here. The trays may be some kind of spring-loaded trays that will automatically pull back when released after having withdrawn an item. Subsequently the tray will than return to the dispensing position and become aligned with the group of item 32 to receive another item 30. In other embodiments the tray 24 may also be motor-driven, which will enable the processor unit 4 to close the tray, for example automatically after a predetermined period of time after a transaction.

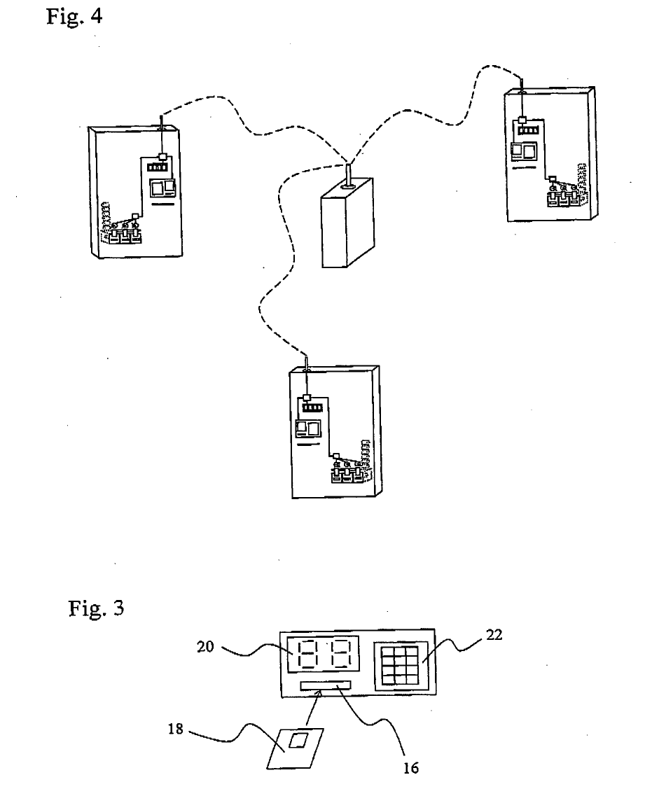

In FIG. 3 the input terminal of the embodiment shown in FIG. 1 or 2 is her illustrated. In a referred embodiment of the present invention it comprises a card reader device 16, a keyboard or control panel 22 and a display 20. The card reader 16 is adapted to read the authentication data stored on a card 18 to be inserted. In alternative embodiments the reader also possesses writing capabilities, for deleting certain authentication information, or writing dispensing transaction data to the card 18. The keyboard 22 will be utilized to enter a personal identification code, for example a personal identification number PIN. Also the keyboard 22 may in some embodiments be used to enter item selection information, i.e. to enable a user to select one or more items or item groups he wishes to withdraw. Yet another possibility is to indicate the termination of a dispensing transaction with the keyboard 22, which can be an alternative to closing and locking the output unit after a certain time interval has passed. On the display 20 the inventive dispensing station can display certain dispensing status information or other information of interest to the user. For example an indication that the selected item or item group is not available at the moment. When using the identification code transfer feature it can be utilized to display the PIN or the user should record for further use.

FIG. 4 shows an embodiment of an inventive dispensing system. It comprises three dispensing stations, and a central computer system, for example a server. The server is equipped with a communication interface corresponding to the interfaces of the dispensing stations. It can so connect to the dispensing stations by wireless connection, mainly to receive dispensing transaction data. But data can also be transmitted to the stations, for example restocking information or updates to the stored authentication data The server receives and stores all the dispensing data sent by the dispensing station, e.g. items and number of items withdrawn by a certain user, or remaining stock of items. With the central server it is easy to keep track of item usage, to schedule restocking, associate certain users with withdrawn items and perform other management objects concerning the dispensing process. Note that besides the wireless connection depicted here, the server and the dispensing stations may also be part of another kind of network, for example an Ethernet network, wherein all dispensing stations and the server could be identified by their own unique IP address or email address. It is also possible to use more than one server, for example one server being located at the laboratory itself and another server located at the dealer responsible for the restocking of the dispensing stations,

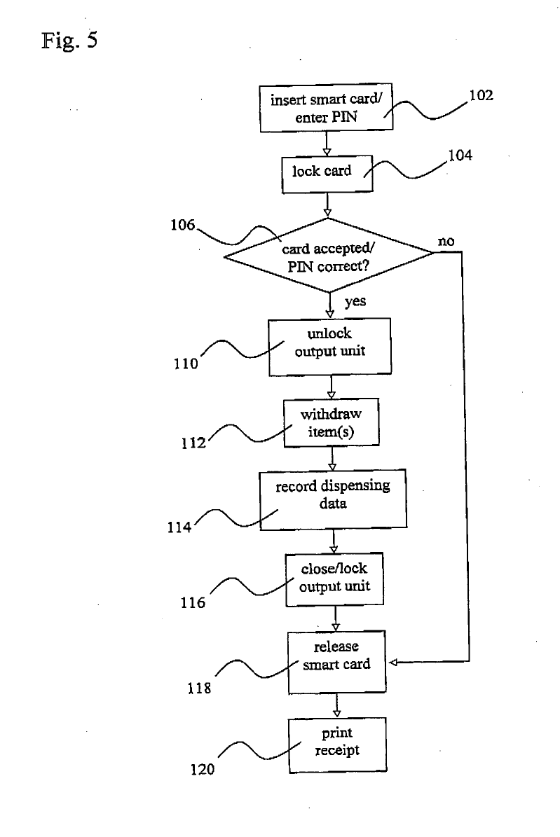

In FIG. 5 the inventive method of dispensing items is illustrated in a flow chart Here it is assumed at identification and authentication is performed with a smart card. In step 102 the smart card is inserted into the input terminal of the dispensing station and the associated PIN code is entered. The dispensing station locks the card in step 104 inside the card slot. If the card is accepted and the entered PIN code is correct (step 106) the process continues. Otherwise authorization is denied, and the PIN code has to be entered again or the card is unlocked and released to be removed. Note that it is also possible to call back the card here, for example if a wrong PIN has been entered three times, to prevent further misuse of a probably stolen card. If authorization was successful, the output unit is unlocked in step 110. The dispensing station can now be opened by the user, and he can withdraw one or more items he desires ( step 112). All data concerning the dispensing transaction is recorded, e.g. time of withdrawal, kind of items removed, user etc. in step 114. Next the output unit is closed and locked again (step 116), to prevent unauthorized use. In step 118 the smart card is released for the user to remove it. Finally the dispensing station prints out (step 120) a receipt indicating what items the user has withdrawn, and possibly other useful information about the dispensing process, name of user, time of withdrawal etc. In case of a limited number of items the user is allowed to withdraw this receipt may also comprise an indication of how many items are left for him to withdraw from the dispensing station. In alternative embodiments of the invention such a receipt can also be sent by SMS to the users mobile phone, or written to the personal identification module, e.g. a smart card or the like, before releasing it.

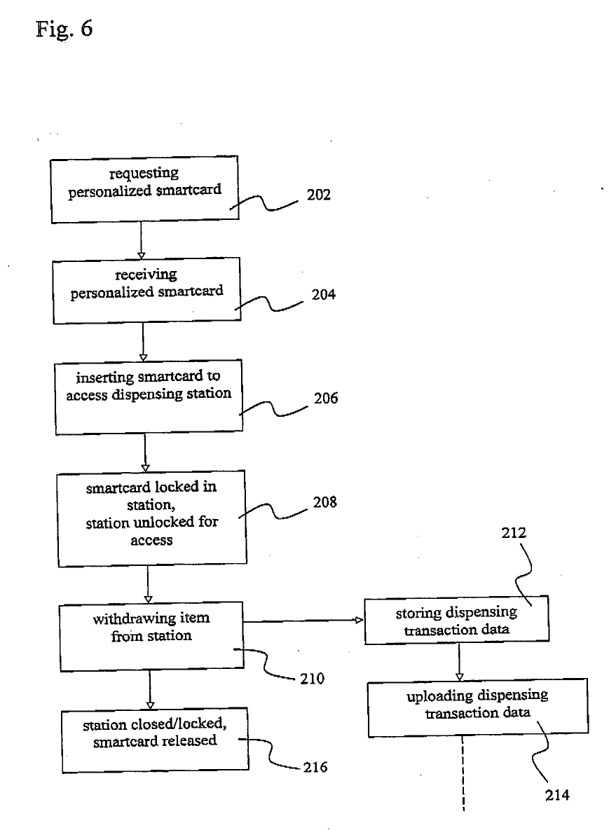

In FIG. 6 an example of an embodiment of the inventive dispensing process is illustrated. Here it is assumed that a person, a researcher for example, has taken notice of a dispensing station according to the present invention, that has been installed in a laboratory or the like. An information will be displayed on the station, informing possible users that a personalized smartcard is required for accessing items in the dispensing station. In step 202 a smartcard is thus requested by a possible new user, for example by fax or email preferably without the use of the dispensing station. Next the smartcard is received by the respective person (step 204). The smartcard is inserted into the dispensing station to access certain items (step 206). After the smartcard has been locked in the station, the station is consequently unlocked for the user to withdraw items (step 208) Next an item is withdrawn from the dispensing station in step 210. The data concerning the dispensing transaction is stored (step 212) in the dispensing station and possibly also on the smartcard. Dispensing transaction data is then uploaded (step 214). This upload can take place accompanying every withdrawal or dispensing transaction, or it could be scheduled for a certain time of day, by night for example. Also, the upload can be performed to just one, or a plurality of recipients, e.g. a restocking firm, a laboratory manager, a firm responsible for the installation of dispensing stations and the like. After the dispensing station is closed again and the door is locked, the smartcard is releases to be removed (step 216).

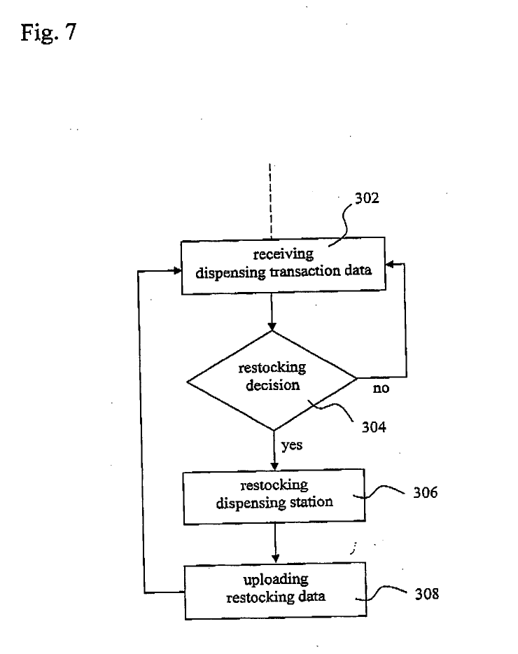

In FIG. 7 a restocking process is illustrated, as it is enabled by embodiments of the inventive dispensing system. Here it is assumed that dispensing transaction data is uploaded by a dispensing station (refer to the description of FIG. 6). The dispensing transaction data is received or downloaded in step 302. Based on this data a restocker can decide (step 304) if restocking is required, for example by updating a data base of the item content of a dispensing station with every download of dispensing transaction data. Or the dispensing transaction data can possibly contain an indication that can be processed to make the decision, i.e. the dispensing station can signal that stocks are low for example. If the restocking decision is positive, the respective dispensing station is being restocked (step 306). Restocking data is consequently uploaded, in most cases to the dispensing station (step 308), to a single or even multiple entities, laboratory manager, restocking dealer firm etc. Note that it may also be possible to connect a download of dispensing transaction data with every single withdrawal, i.e. the download is then triggered by the dispensing station rather than a restocking dealer. This would enable to keep a data base (located at a restocking dealer for example) updated to decide when restocking is necessary, whereas the dispensing station itself would not have to know the remaining content of a certain item. In this case, which may be appropriate in certain situations, the upload of restocking data would not be performed to the dispensing station, as the dispensing station itself will then not keep track of the item content. Restocking data can also be uploaded to the dispensing station by using a special smartcard the dispensing station will recognize, on which the restocking data is stored. This data will then be read from the special card.

In its simplest case the inventive dispensing station will store only one sort of item. In this case it is in principle irrelevant if the locking mechanism locks the output unit as a whole, or the single or multiple trays comprised therein, as there is only one kind of item available. With dispensing units storing a plurality of different items or item groups, that comprise a corresponding number of trays the locking mechanism will advantageously have additional features. It is assumed that there are certain categories of laboratory items with different properties, i.e. harmless glass pans, slides, slide covers and the like, but also items containing hazardous materials or possessing dangerous properties. For example radioactive, poisonous or infective materials. There are also other possibilities conceivable, for example to restrict certain groups of users (students, professors, guests etc.) to different categories of items they are allowed to withdraw from the dispensing station. The present invention also provides a feature to achieve a corresponding access control. Therefore the different trays containing different categories of more or less harmless/hazardous, or cheap/expensive items can be selectively locked by the locking mechanism. Depending on the user, e.g. the clearance level associated to the user, only the trays containing items he is allowed to withdraw are unlocked upon successful authorization. This feature of the invention will be very useful in a laboratory to prevent students from handling reagents or devices they are not trained or allowed to use.

Freezer units may comprise a plurality of zones with different temperatures, for storing items requiring different individual temperature profiles. Usually such zones will be isolated against each other to maintain the respective temperatures, but it is also possible to use freezer units comprising a temperature gradient, wherein items must be stored in the corresponding location providing the desired temperature. A combination of those two possibilities is of course conceivable.

It should be noted that, while the preceding description of the present invention referred to the use of freezer/refrigerator units, it is in no way restricted to that. The present invention may be utilized in conjunction with other items requiring specific storage conditions as well. It is particularly useful with such items, where the specific storage conditions require a properly sealed storage unit comprised in the output unit. Examples other than freezers/refrigerators may also be heater units for storing items that must be kept above a certain minimum temperature.

Particularly dispensing stations containing items requiring certain storage conditions will be advantageously be used together with a preferred embodiment. In case of a dispensing station with a freezer unit the basic construction will usually provide multiple inner trays within the freezing unit, and an outer sealing door ensuring thermal isolation. It is thus useful to let the user select the items he wants prior to opening the outer door, because the items have to be stored within a predetermined temperature interval. To maintain that temperature the time the outer door is left open should be kept as short as possible. So by an inventive dispensing station the user will be offered to select the wanted items prior to unlocking and opening the door. This will keep the time short it takes to withdraw the items from the subsequently unlocked trays corresponding to his selection. To enable a selection a kind of key guide will be provided on the dispensing station, indicating what items are contained, and possibly in which trays. Of course there can also be tags on the trays itself indicating the content.

Also, while the preceding description focused on using smart cards or the like, also other portable personal identification modules or devices can be used, for example USB memory sticks, bluetooth devices or other suitable modules.

After a dispensing transaction is finished the user is informed to release his smartcard or the like, and his receipt. A beep tone can be utilized to remind the user to remove his card, that will be sounded until the card has been removed.

The sending of dispensing transaction data by the communication interface to one or more servers for example may occur at one ore more pre-programed events, including a withdrawal, a certain time, or if the amount of items in stock achieves a certain threshold amount. It is also conceivable to request a data download from a dispensing station, e.g. once a day. The data may of course be sent to more than one entity at the same time. An example would be to send the dispensing data to a central server of the respective laboratory, the dealer responsible or operating the dispensing stations, and users as well.

Each tray of an inventive dispensing station may be equipped with a LED or the like, to signal to the user or a person responsible for restocking if and which tray is empty or only contains less than the predetermined minimal amount of items.

The remaining amount of items may either be sensed directly, with the sensor device. Or it can easily be derived by subtracting withdrawn items from a stored number of previously available items. Either way getting below a predetermined threshold amount will be noticed and a restocking request can be issued.

1. An unmanned dispensing station for laboratory items, comprising:
an input terminal for identifying a user and authenticating said user;
a central processing unit connected to said input terminal;
an output unit comprising a sensor device connected to said central processing unit;
a memory device connected to said central processing unit; and
a communication interface for transceiving data, connected to said central processing unit;
wherein said output unit comprises a locking mechanism to unlock said output unit for access of an authorized user and to close and lock said output unit to prevent unauthorized access,
wherein said output unit comprises at least a first group of laboratory items arranged in a first order, wherein at least one item of said first group is located in a dispensing position, to be withdrawn from said output unit by said user,
wherein said sensor device is positioned in the vicinity of said dispensing position to detect a withdrawal,
wherein said memory device is adapted to store dispensing transaction data comprising the identity of said authorized user and the item group of said item, as well as withdrawal timing information,
wherein said central processing unit is adapted to control said locking mechanism to unlock said output unit upon successful authentication of said user, and to close and lock said output unit upon termination of a dispensing transaction, wherein said central processing unit is adapted to read dispensing transaction data from said memory and to send it to said communication interface.

2. The dispensing station according to claim 1, wherein said input terminal comprises:
an access device for accepting a personal identification module of said user, wherein said access device is adapted to read personal authentication data stored on said personal identification module, to compare it with user authentication data stored in said memory device and to issue an authentication signal to said central processing unit upon matching of said read and said stored data.

3. The dispensing station according to claim 2, wherein said access device is adapted to lock said personal identification module during a dispensing transaction, and to release said personal identification module for removal by said user only after said locking mechanism has locked said output unit subsequent to the termination of a dispensing transaction.

4. The dispensing station according to claim 1, wherein said access device comprises an output section adapted to write dispensing transaction data to said personal identification module.

5. The dispensing station according to claim 1, wherein said input terminal comprises:
a scanning device for scanning biometrical data of said user, adapted to compare said data with biometrical user data stored in said memory device and to issue an authentication signal to said central processing unit upon matching of said scanned and said stored data;
wherein said biometrical data is selected from the group containing fingerprint, eye iris, face image and voice data.

6. The dispensing station according to claim 4, wherein said input terminal comprises:
a display for displaying user instruction and dispensing status information; and
an input device for entering a personal identification code of said user;
wherein said access device is adapted to transfer said personal identification code to said memory device, and said output section is adapted to delete any personal identification code stored on said personal identification module.

7. The dispensing station according to claim 1, wherein said output unit comprises a refrigerating or freezing device for cooling or freezing of items comprised in said output unit, wherein at least all said laboratory items are contained in said refrigerating or freezing device, and wherein said refrigerating or freezing device may comprise a plurality of zones with different temperatures or one or more zones with a temperature gradient.

8. The dispensing station according to claim 1, wherein said input terminal comprises a printer adapted to print out dispensing transaction data.

9. The dispensing station according to claim 1, wherein said communication interface comprises a wireless communication module for wireless transmitting of said dispensing transaction data to at least one destination address.

10. The dispensing station according to claim 9, wherein said wireless communication module comprises a transmission section for preparing and sending an electronic mail containing dispensing transaction data to at least one destination address.

11. The dispensing station according to claim 9, wherein said wireless communication module comprises a transmission section for preparing dispensing transaction data for transmission to a web site.

12. The dispensing station according to claim 9, wherein said wireless communication module comprises a transmission section for preparing and sending a short message (SMS) containing dispensing transaction data to at least one phone number.

13. The dispensing station according to claim 1, wherein said output unit comprises at least one movable tray adapted to be displaced between said dispensing position in which said tray is aligned with said order of said group of items to receive one of said items, and a removal position in which said tray is positioned to enable said user to remove an item.

14. The dispensing station according to claim 9, wherein said wireless communication module comprises a receiving section for receiving restocking data comprising an item identification and an amount of reloaded items, wherein said receiving section is adapted to transmit said restocking data to said central processing unit for updating the content of said memory device according to said restocking data.

15. The dispensing station according to claim 13, wherein said output unit comprises at least two trays, and said locking mechanism is adapted to selectively lock and unlock at least one of said at least two trays, and said central processing unit is adapted to control said selective locking or unlocking depending on said authorization of said user.

16. A method of dispensing laboratory items, comprising:
identifying and authenticating a user;
unlocking an output unit for withdrawal of items by said authenticated user;
sensing a dispensing transaction of said user;
recording dispensing transaction data comprising the identity of said authorized user and the item identification, as well as withdrawal timing information;
determining the termination of said dispensing transaction and locking said output unit; and
transmitting said recorded dispensing transaction data to at least one destination address.

17. The method according to claim 16, wherein the termination of said dispensing transaction is determined by sensing that a predetermined period of time after unlocking of said output unit or a dispensing transaction has passed.

18. The method according to claim 16, wherein the termination of said dispensing transaction is determined by sensing an indication of the termination entered by said user.

19. The method according to claim 16, comprising:
storing the number of currently available items in said memory device;
updating said number after the termination of a dispensing transaction according to said recorded dispensing transaction data; and
transmitting a restocking request if said amount is less than a predetermined threshold amount.

20. The method according to claim 16, comprising:
outputting recorded dispensing transaction data by printing out or displaying said data.

21. The method according to claim 16, wherein said user is authenticated by:
reading a personal identification module;
comparing personal authentication data read from said identification module with previously stored authentication data; and
issuing an authentication signal upon a match of the compared authentication data.

22. The method according to claim 16, wherein said personal identification module is locked during a dispensing transaction, and released only after said output unit has been locked subsequent to the termination of a dispensing transaction.

23. The method according to claim 16, wherein a personal identification code is received from said user and compared with a personal identification code stored on said personal identification module, wherein said authentication signal is issued only upon a match of both codes.

24. The method according to claim 23, comprising:
recording said personal identification code upon a successful authentication; and
deleting said personal identification code from said personal identification module.

25. The method according to claim 21, comprising writing dispensing transaction data to said personal identification module.

26. The method according to claim 16, wherein said user is authenticated by:
scanning biometrical data of said user;
comparing said biometrical data with previously stored biometrical data; and
issuing an authentication signal upon a match of the compared biometrical data.

27. The method according to claim 16, comprising transmitting dispensing transaction data to a web site.

28. The method according to claim 16, comprising preparing and sending an electronic mail containing dispensing transaction data to at least one address.

29. The method according to claim 16, comprising preparing and sending a short message (SMS) containing dispensing transaction data to at least one phone number.

30. The method according to claim 19, comprising:
receiving restocking data comprising an item identification and an amount of restocked items; and
updating said number of available items.

31. The method according to claim 16, wherein said output unit comprises at least two trays for dispensing items, wherein said unlocking of said output unit comprises:
selectively unlocking at least one of said trays depending on said authorization of said user.

32. The method according to claim 16, wherein said output unit comprises at least two trays for dispensing items, comprising:
receiving an item selection from said user and unlocking at least one of said trays corresponding to said selection.

33. A system for dispensing laboratory items, comprising:
at least one dispensing station, comprising:
an input terminal for identifying a user and authenticating said user:
a central processing unit connected to said input terminal;
an output unit comprising a sensor device connected to said central processing unit;
a memory device connected to said central processing unit; and
a communication interface for transceiving data, connected to said central processing unit;
wherein said output unit comprises a locking mechanism to unlock said output unit for access of an authorized user and to close and lock said output unit to prevent unauthorized access,
wherein said output unit comprises at least a first group of laboratory items arranged in a first order, wherein at least one item of said first group is located in a dispensing position, to be withdrawn from said output unit by said user,
wherein said sensor device is positioned in the vicinity of said dispensing position to detect a withdrawal,
wherein said memory device is adapted to store dispensing transaction data comprising the identity of said authorized user and the item group of said item, as well as withdrawal timing information, and
wherein said central processing unit is adapted to control said locking mechanism to unlock said output unit upon successful authentication of said user, and to close and lock said output unit upon termination of a dispensing transaction, wherein said central processing unit is adapted to read dispensing transaction data from said memory and to send it to said communication interface; and
a computer system comprising at least one communication interface;
wherein said at least one communication interface is adapted to connect with said at least one dispensing station, to receive dispensing transaction data.

34. (canceled)

35. A computer readable medium that includes a program executing steps for dispensing laboratory items, the program execution comprising:
identifying and authenticating a user;
unlocking an output unit for withdrawal of items by said authenticated user;
sensing a dispensing transaction of said user;
recording dispensing transaction data comprising the identity of said authorized user and the item identification, as well as withdrawal timing information;
determining the termination of said dispensing transaction and locking said output unit; and
transmitting said recorded dispensing transaction data to at least one destination address.

36. A computer readable medium that includes a program, downloadable from a server,executing steps for dispensing laboratory items, the program execution comprising:
identifying and authenticating a user;
unlocking an output unit for withdrawal of items by said authenticated user;
sensing a dispensing transaction of said user;
recording dispensing transaction data comprising the identity of said authorized user and the item identification, as well as withdrawal timing information;
determining the termination of said dispensing transaction and locking said output unit; and
transmitting said recorded dispensing transaction data to at least one destination address.

37. A computer data signal embodied in a carrier wave and representing a program that instructs a computer to perform steps for dispensing laboratory items, the program instruction comprising:
identifying and authenticating a user;
unlocking an output unit for withdrawal of items by said authenticated user;
sensing a dispensing transaction of said user;
recording dispensing transaction data comprising the identity of said authorized user and the item identification, as well as withdrawal timing information;
determining the termination of said dispensing transaction and locking said output unit; and
transmitting said recorded dispensing transaction data to at least one destination address.
